(19) United States
(12) Patent Application Publication
(10) Pub. No.: US 2023/0114277 A1
(43) Pub. Date: Apr. 13, 2023

(54) SYSTEM AND METHOD FOR OPERATIONS MANAGEMENT

(71) Applicant: Gaurav Deshmukh, Allen, TX (US)

(72) Inventor: Gaurav Deshmukh, Allen, TX (US)

(21) Appl. No.: 17/955,377

(22) Filed: Sep. 28, 2022

Related U.S. Application Data
(60) Provisional application No. 63/249,743, filed on Sep. 29, 2021.

(51) Int. Cl. G06Q 10/06; G06Q 10/10

(52) U.S. Cl. CPC G06Q 10/063112; G06Q 10/103; G06Q 10/063116

(57) ABSTRACT

A method and system for operation management, providing an interactive communication interface and operation management for improvement and optimization of field operations and experience, quality, and productivity of the field workforce for businesses using cloud-based computer programs and mobile technologies. The system and method that enables the use of Intuitive User Interfaces, Artificial Intelligence, Bluetooth, cellular and WiFi network capabilities, GPS Location Tracking, Maps, Camera Pictures and Augmented Reality, Bar Code and QR Code scanning, Dynamic Form based data inputs and offline mode of operations to streamline the complex business processes. This disclosure further provides plug-and-play modules that can be modified using low code, no-code approaches to fit specific business processes which includes door-to-door sales, service installation, service repair, service maintenance, and site surveys.

### TECHNICAL FIELD

The present disclosure relates to a method and system for operation management, more particularly the disclosure relates to a system and method for providing an interactive communication interface and operation management for optimization of field operations and experience, quality, and productivity of the field workforce.

### BACKGROUND

In today’s world, field service is an integral part and an important aspect of most of the industry and businesses. Many organizations and businesses have field workforces. Though the field workforce plays a vital role in establishing, executing, and enhancing business, and industrial growth, it also put forth challenges of particularly field workforce management, operational management, and general business management.

For the completion of the assigned work, it is of utmost importance that the field workforce is well informed about the exact details of the work assignment, and requirements for successful completion of the work assignment and remains connected to the work assigning entity for any required assistance in terms of the required data or other kinds of assistance and updating status of the assigned work.

Thus, the field workforces and the entity managing work/projects with them always face challenges and difficulties in remote collaboration, tracking tasks and productivity, synchronizing working from different locations and time zones.

With the advent of technology, many systems and tools have been developed to address the difficulties and challenges faced in managing the field workforce.

In such systems, many field users still rely on the use of laptops to view and complete their work orders, especially in complex business environments. The use of laptops is still dependent upon hotspot connectivity. Also, desktop computer or laptop-based applications and difficulty in handling the device results in limited use of the device for field activities. Though, there are standalone mobile apps available; they do not offer enterprise-grade features, security, or data management required by large enterprises. Most of these apps are static in nature and do not offer various capabilities that are required in an enterprise field service operations platform. Also, these systems are communication network connectivity dependent and hence fails to provide seamlessly integrated system use experience to the field workforce.

Further, such systems do not offer various capabilities that are required in an enterprise field service operations platform to manage the field workforce and assist the field workforce to complete the work with quality and enhance the productivity and experience of the field workforce.

Further, these systems are very rigid in their construction, structure, and execution such that adapting to a new workflow becomes almost impossible without a humongous redesign of the system’s excessive manual efforts.

Therefore, there is a need for an interactive communication interface system and method thereof that provides various capabilities that are required in an enterprise field service operations platform, provides seamlessly integrated system use experience to the field workforce, optimizes field operations, assists the field workforce to complete the work with quality and enhance productivity and experience of the field workforce and is flexible to accommodate new business flows, processes with minimal or no manual efforts.

For the reasons stated above, which will become apparent to those skilled in the art upon reading and understanding the specification, there is a need in the art for operation management, a system and method for providing an interactive communication interface for the best user experience in the data, information exchange and communication, providing various capabilities that are required in an enterprise field service operations platform, optimizing field operations and experience, quality, and productivity of the field workforce, that is useable, scalable and independent of new technology platforms, uses minimum resources that are easy and cost-effectively maintained and is portable and can be deployed anywhere in very little time.

### SUMMARY

The present disclosure provides a system and method thereof for optimization of field operations and experience, quality, and productivity of the field workforce, the system and method thereof is a cloud-based computer and mobile platform that uses Artificial Intelligence (AI), Cellular and Wireless networks, Bluetooth, GPS location and Camera to view and complete field assignments

According to one of the embodiments, the system and method thereof of the present disclosure is directed to improve the experience, quality, and productivity of the field workforce and optimize field operations for businesses using a cloud-based computer program and mobile technologies. The present disclosure enables the client/field devices to use Intuitive User Interfaces, Artificial Intelligence, Bluetooth, cellular and WiFi network capabilities, GPS Location Tracking, Maps, Camera Pictures and Augmented Reality, Bar Code and QR Code scanning, Dynamic Form based data inputs and offline mode of operations. to streamline the complex business processes. This present disclosure further provides plug-and-play modules that can be modified using low code/no-code approaches to fit specific business processes.

The present disclosure discloses a computer-implemented platform and method thereof for providing an interactive communication interface and operation management for optimization of field operations and experience, quality, and productivity of the field workforce. The computer-implemented platform includes a second memory in communication with a second processor, a plurality of client/field devices, and at least one server module, the server module configured through cloud computing architecture. The memory is configured to store a set of pre-determined rules. The processor is configured to generate system processing commands. The client/field devices include any and all portable mobile devices capable of installing, configuring, and executing an application, and having a third processor in communication with a third memory. The third processor includes at least one processor in communication with at least one memory. The third memory is also communicatively coupled to a plurality of utility components which includes camera, bar code and QR scanner, interactive display, and communication module capable of providing connectivity and communication over various network protocols.

The server module includes at least one client-server configured through cloud computing architecture to provide the system platform of the system of the present disclosure. The system platform, hereinafter also referred to as platform, is configured to provide a configuration web portal, a field tech App and a manager App, both Apps hereinafter collectively also referred to as FieldServe App. The system platform comprises at least one processor and at least one memory communicatively coupled to the processor. The system platform is configured to include a modular interface, a cloud module, an AI module, a Low/No code module, an user management module, an experienced management module, a location service module, a cloud-native/agnostic infra module, an engagement module, a business processes controllers module, a device capabilities module, a database and file storage module, a collaboration module, an automation and self-help module, a technology On module, a security management module and an integration gateway third-party connectors module configured to provide connectivity to existing Business and Operations Support Systems (B/OSS) and third party systems. The client/field device having FieldServe App configured, communicates with the client-server, the client-server configured through cloud computing architecture to provide the system platform of the system of the present disclosure to execute the respective functionality of the system and method thereof.

### DESCRIPTION OF THE DRAWINGS

The embodiments can be better understood with reference to the following drawings and description. The components in the figures are not necessarily to scale, the emphasis instead being placed upon illustrating the principles of the embodiments. Moreover, the figures, similar to reference numerals designate corresponding parts throughout the different views.

Reference will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments.

The above and other objects, features, and advantages of the present disclosure will be more clearly understood from the following detailed description taken in conjunction with the accompanying drawings, in which:

FIG. 1A, FIG. 1B and FIG. 1C illustrate a schematic diagram depicting a computer implemented platform for providing an interactive communication interface and operation management for optimization of field operations and experience, quality and productivity of the field workforce in a client-server arrangement, according to an exemplary implementation of the present disclosure.

FIG. 2 illustrates a modular structure of the system platform of the present disclosure according to one or more embodiments of the present disclosure.

FIG. 3 illustrates some of the features of the present disclosure according to one or more embodiments of the present disclosure.

FIG. 4A, FIG. 4B and FIG. 4C illustrate an execution flow of the method of the present disclosure duly executed by the system of the present disclosure according to one of the embodiments of the present disclosure.

It should be appreciated by those skilled in the art that any block diagrams herein represent conceptual views of illustrative systems embodying the principles of the present disclosure. Similarly, it will be appreciated that any flowcharts and flow diagrams represent various processes which may be substantially represented in computer readable medium and so executed by a computer or processor, whether or not such computer or processor is explicitly shown.

### DETAILED DESCRIPTION

The embodiments herein provide a method and system for operation management, more particularly the disclosure relates to a system and method for providing interactive communication interface and operation management for optimization of field operations and experience, quality and productivity of the field workforce. Further, the embodiments may be easily implemented in interactive communication and management structures. Embodiments may also be implemented as one or more applications performed by stand alone or embedded systems.

The present disclosure can overcome the limitations of these prior art of system for creating, assigning, and completing work assignments, including recording and transmitting all relevant work-related materials between managers and staff electronically and provide improved system and method thereof that provides various capabilities that are required in an enterprise field service operations platform, provide seamless integrated system use experience to the field workforce, optimizes field operations, assist the field workforce to complete the work with quality and enhance productivity and experience of the field workforce and is flexible to accommodate new business flows, processes with minimal or no manual efforts, while efficiently increasing the throughput of the field workforce and profitability. The present disclosure provides a method and system for operation management, more particularly the disclosure relates to a system and method for providing interactive communication interface and operation management for optimization of field operations and experience, quality and productivity of the field workforce. The present disclosure provides a system and method for providing interactive communication interface for best user experience in the data, information exchange and communication, providing various capabilities that are required in an enterprise field service operations platform, optimizing field operations and experience, quality and productivity of the field workforce, that is useable, scalable and independent of new technology platforms, uses minimum resources that is easy and cost effectively maintained and is portable and can be deployed anywhere in very little time

In the following description, for the purpose of explanation, specific details are set forth in order to provide an understanding of the present disclosure. It will be apparent, however, to one skilled in the art that the present disclosure may be practiced without these details. One skilled in the art will recognize that embodiments of the present disclosure, some of which are described below, may be incorporated into a number of systems.

Furthermore, connections between components and/or modules within the figures are not intended to be limited to direct connections. Rather, these components and modules may be modified, re-formatted or otherwise changed by intermediary components and modules.

References in the present disclosure to “one embodiment” or “an embodiment” mean that a particular feature, structure, characteristic, or function described in connection with the embodiment is included in at least one embodiment of the disclosure. The appearances of the phrase “in one embodiment” in various places in the specification are not necessarily all referring to the same embodiment.

Hereinafter, embodiments will be described in detail. For clarity of the description, known constructions and functions will be omitted.

Parts of the description may be presented in terms of operations performed by at least one electrical / electronic circuit, a computer system, using terms which includes data, state, link, fault and packet, consistent with the manner commonly employed by those skilled in the art to convey the substance of their work to others skilled in the art. As is well understood by those skilled in the art, these quantities take the form of data stored/transferred in the form of non-transitory, computer-readable electrical, magnetic, or optical signals capable of being stored, transferred, combined, and otherwise manipulated through mechanical and electrical components of the computer system; and the term computer system includes general purpose as well as special purpose data processing machines, switches, that are standalone, adjunct or embedded. For instance, some embodiments may be implemented by a processing system that executes program instructions so as to cause the processing system to perform operations involved in one or more of the methods described herein. The program instructions may be computer-readable code, which includes compiled or non-compiled program logic and/or machine code, stored in a data storage that takes the form of a non-transitory computer-readable medium, which includes a magnetic, optical, and/or flash data storage medium. Moreover, such processing system and/or data storage may be implemented using a single computer system or may be distributed across multiple computer systems (e.g., servers) that are communicatively linked through a network to allow the computer systems to operate in a coordinated manner.

Embodiments of the present disclosure include various steps, which will be described below. The steps may be performed by hardware components or may be embodied in machine-executable instructions, which may be used to cause a general-purpose or special purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, which includes ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In some embodiments, the systems may be configured as a distributed system where one or more components of the system are distributed across one or more networks in a cloud computing system.

As used in the description herein, the meaning of “a, “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure.

In an implementation according to one of the embodiments, the present disclosure is a system and method thereof for optimization of field operations and experience, quality and productivity of the field workforce, the system and method thereof is a cloud-based computer and mobile platform that uses Artificial Intelligence, Cellular and Wireless Network, Bluetooth, GPS location and Camera to view and complete field assignments.

According to one of the embodiments, the system and method thereof of the present disclosure is directed to improve the experience, quality and productivity of the field workforce and optimizes field operations for the businesses using cloud-based computer program and mobile technologies. The present disclosure enables use of Intuitive User Interfaces, Artificial Intelligence, Bluetooth, cellular and WiFi network capabilities, GPS Location Tracking, Maps, Camera Pictures and Augmented Reality, Bar Code and QR Code scanning, Dynamic Form based data inputs and offline mode of operations. to streamline the complex business processes. This present disclosure further provides plug and play modules that can be modified using low code, no-code approaches to fit the specific business processes such door-to-door sales, service installation, service repair, service maintenance and site surveys.

In an implementation according to one of the embodiments, the system and method thereof of the present disclosure is configured to offer various capabilities that are required in an enterprise field service operations platform which includes artificial intelligence, Bluetooth Connectivity to their network devices, GPS and Location Tracking and use of it for the maps and drive functions, offline mode of operations so Field Agent can work in low or no cellular network areas including remote places and basements.

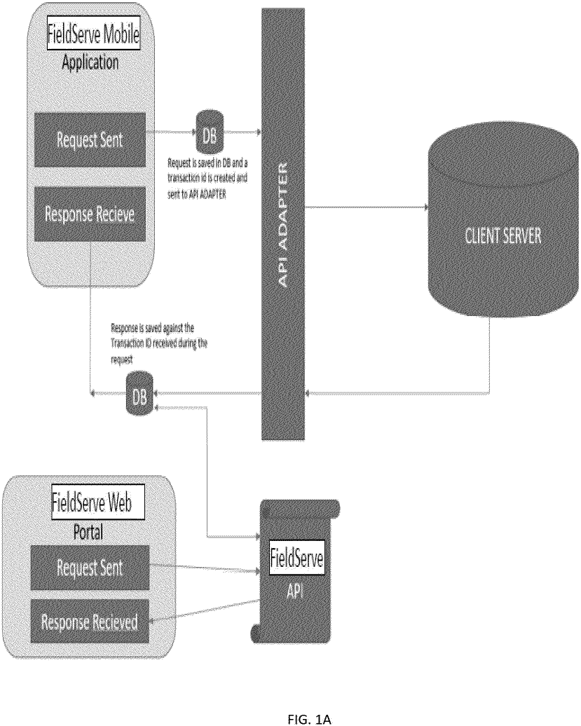

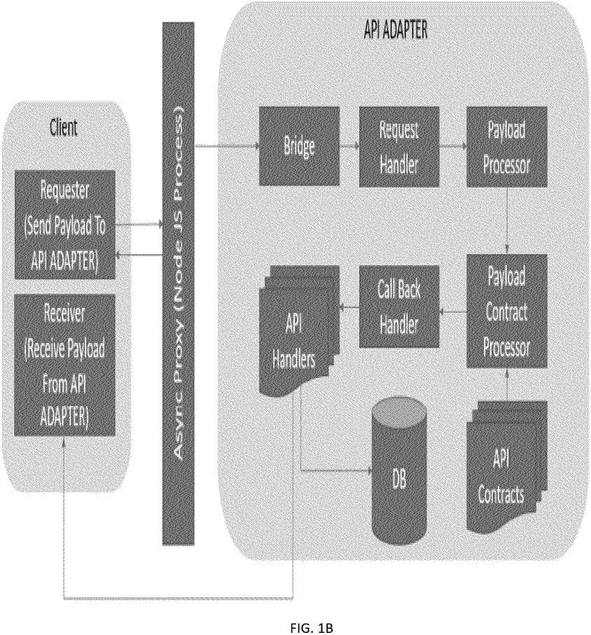

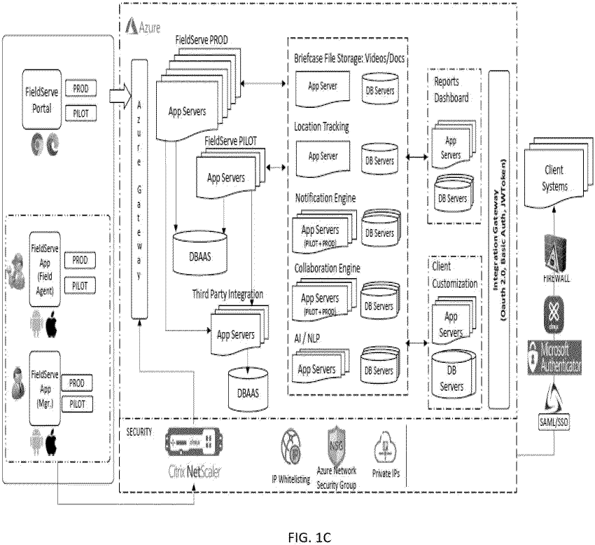

FIG. 1A, FIG. 1B, and FIG. 1C illustrate a schematic diagram depicting a computer implemented platform (20) for providing an interactive communication interface and operation management for optimization of field operations and experience, quality and productivity of the field workforce in a client-server arrangement, according to an exemplary implementation of the present disclosure.

In another implementation, the present disclosure discloses a computer implemented platform (20) for providing an interactive communication interface and operation management for optimization of field operations and experience, quality and productivity of the field workforce. The platform includes a second memory in communication with a processor, a plurality of client/field devices, and at least one application configured in the second memory consists of a set of pre-determined rules executable by the second processor and configured through cloud computing architecture. The second memory is configured to store a set of pre-determined rules executable by the second processor, thereby generating system processing commands. The client/field devices include any and all portable mobile devices capable of installing, configuring and executing an application, and having a third processor in communication with a third memory and utility components facilitating data connectivity and communication over network protocol. In one of the exemplary embodiments of the present disclosure, the third processor comprising at least one processor in communication with at least one memory, the memory communicatively coupled to the processor, utility components which includes an image capturing device which includes camera, bar code and QR scanner, interactive display, communication module capable of providing connectivity and communicate over various network protocol.

The server module (10) includes at least one client-server configured through cloud computing architecture to provide the system platform of the system of the present disclosure. The system platform, hereinafter also referred to as platform, is configured to provide a configuration web portal, a field tech Application module and a manager Application module both Application modules are hereinafter collectively also referred to as FieldServe Application (35). The system platform comprises a first processor communicatively coupled to a first memory with at least one server module (10) configured in a cloud computing architecture. The first processor includes at least one processor in communication with at least one memory. The first processor is configured to include a modular interface, a cloud module, an AI module, a Low/No code module, an user management module, an experienced management module, a location service module, a cloud-native/agnostic infra module, an engagement module, a business processes controllers module, a device capabilities module, a database and file storage module, a collaboration module, an automation and self-help module, a technology On the module, a security management module and an integration gateway third-party connectors module configured to provide connectivity to existing Business/Operation Support Systems (B/OSS), and third party systems.

As illustrated in FIG. 1A, FIG. 1B and FIG. 1C, a FieldServe Mobile (30), the FieldServe Mobile (30) being a client/field device having FieldServe Application (35) configured, communicates with the client-server, the client-server configured through cloud computing architecture to provide the system platform of the system of the present disclosure to execute the respective functionality of the system and method thereof. The client/field device is configured with an application module that communicates with the client-server over the communication network.

In one of the implementations according to one of the embodiments, the system and method of the present disclosure is configured to leverage cloud and advanced mobile capabilities to improve field user experience, productivity, and quality. The system and method of the present disclosure is configured to use multi-tenant cloud architecture with pre-built libraries of the common business functions that enterprises need. Thus, business and their field users can be quickly onboarded to a cloud platform. The system and method of the present disclosure is further configured to provide configurable low code, no code approaches, such that a plurality of business processes are configured to meet the specific needs. The system and method thereof facilitate the business administrators to turn on and turn off the modules per the business process. The system and method thereof provide and include a mobile application configured to utilize the secured connection to the cloud platform, and securely downloads the required configuration parameters that can be used during the offline mode in case of network connectivity loss. The Mobile application is further configured to utilize advanced device capabilities which includes Bluetooth, WiFi and Cellular Antennas, GPS and Location tracking, Form based data inputs, Camera, Augmented Reality, Bar Code and QR Code scanning. to enable field users to complete their work assignment. These capabilities are used in various business processes including door-to-door sales, service installation, service maintenance, service repair, training, schedule and leave management.

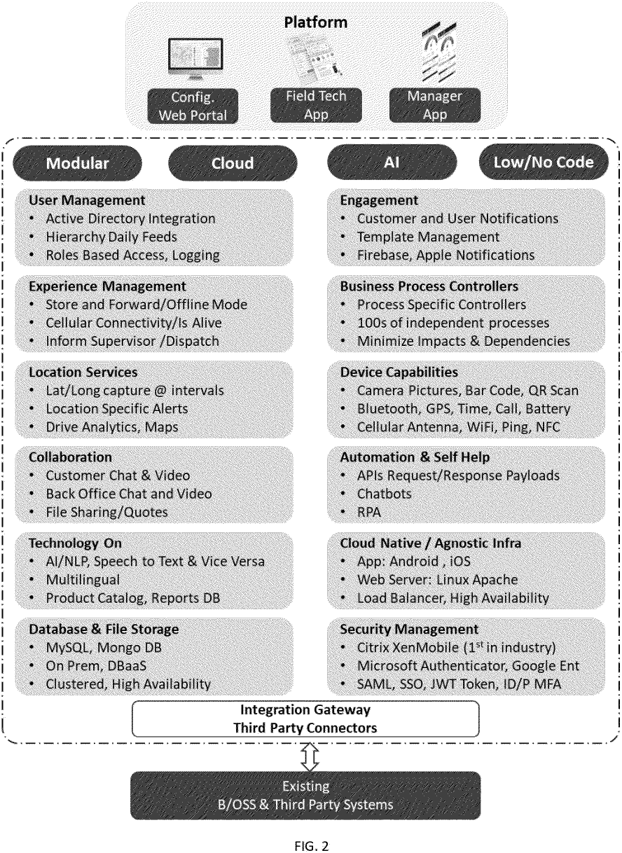

FIG. 2 illustrates the modular structure of the system platform of the present disclosure according to one or more embodiments of the present disclosure. The system platform, hereinafter also referred to as platform, is configured to provide a configuration web portal hereinafter also referred to as FieldServe cloud configuration Portal/ Configuration portal, a field tech Application hereinafter also referred to as FieldServe Application (field agent), and manager Application hereinafter also referred as FieldServe Application (mgr.) and both Application hereinafter collectively also referred to as FieldServe Application (35). The system platform comprises at least one processor and at least one memory communicatively coupled to the processor, the processor is configured to embed within itself and include a modular interface, a cloud module, an AI module, a Low/No code module, an user management module, an experienced management module, a location service module, a cloud-native/agnostic infra module, an engagement module, a business processes controllers module, a device capabilities module, a database and file storage module, a collaboration module, an automation and self-help module, a technology On module, a security management module and an integration gateway third-party connectors module configured to provide connectivity to existing Business and Operations Support Systems (B/OSS) and third party systems.

The modular interface is configured to establish and manage synchronous processing and functional execution of the various modules constituting the platform.

The cloud module is configured to establish the cloud functionality of the system platform and provide seamless integration of the platform to the cloud systems adopted.

The AI module is configured to provide artificial intelligence capabilities and functionalities to the various modules constituting the system platform and the FieldServe Application (35).

The Low/No code module is configured to provide seamless, runtime integration of various business processes to the platform through the Low/No code approach and functionalities which includes drag and drop option to build the input forms that can be used for various business processes based on the input parameters configured, the platform provides automatic API (Application Programming Interface) details including request and response structures for a representational state transfer (REST) API usage.

The user management module is configured to provide active directory integration, hierarchy daily feeds, roles-based access, and logging.

The experience management module is configured to provide two-way communication and engagement between field agent and the customer, store and forward the work execution status and experience of the field agent in online/offline mode, track the cellular connectivity status of the device and determine if the device is alive, communicate and inform status to supervisor/dispatch teams.

The location service module is configured to capture geographic coordinates which includes latitude and longitude information of a client/field device at regular predefined, configurable intervals, generate and provide location-specific alerts, and generate drive analytics and maps for the drive-through for the field agent.

The cloud-native/agnostic infra module is configured to establish and provide infra which includes Android®, iOS® operating systems for FieldServe Application (35), and web servers including but not limited to Linux® Apache. The cloud-native/agnostic infra module is further configured to provide a load balancer and maintain high availability of the platform to the field devices hosting the FieldServe Application (35).

The engagement module is configured to generate, provide and manage customer and user notifications, perform the template management and generate, provide and manage other notifications for Firebase® and Apple® notifications.

The business processes controller module is configured to configure a plurality of controllers which includes process-specific controllers to manage the execution of hundreds of independent processes by minimizing the impact on processing and dependencies.

The device capabilities module is configured to integrate, establish and manage a plurality of devices/components which includes camera, bar code scanner, QR scanner, Bluetooth, GPS, Time, Call, Battery, Cellular antenna, WiFi, Ping and NFC (Near Field Communication) to include, integrate, execute and manage the associated functionalities of these various devices over the platform and client/field devices.

The database and file storage module is configured to provide and manage databases and provide functionalities which includes On-Prem, and DBaaS (Database as a Service) through clustered architecture to provide high availability.

The collaboration module is configured to provide functionalities which includes customer chat & video, back-office chat & video, and file sharing/quotations.

The automation and self-help module is configured to provide and manage APIs (Application Programming Interface) Request/Response Payloads, chatbots, and RPA (Robotic Process Automation).

The technology On module is configured to provide functionalities which includes AI/NLP (Artificial Intelligence Natural Language Processing), speech to text & vice versa, multilingual, product catalog, and reports Database.

The security management module is configured to provide a security suit by adopting various security technologies and implementations which includes Citrix® XenMobile, Microsoft® Authenticator, Google® Ent, SAML (Security Assertion Markup Language), SSO (Single Sign On), JWT (JASON Web Token) Token and ID/P (ID and Password) MFA (Multi Factor Authentication).

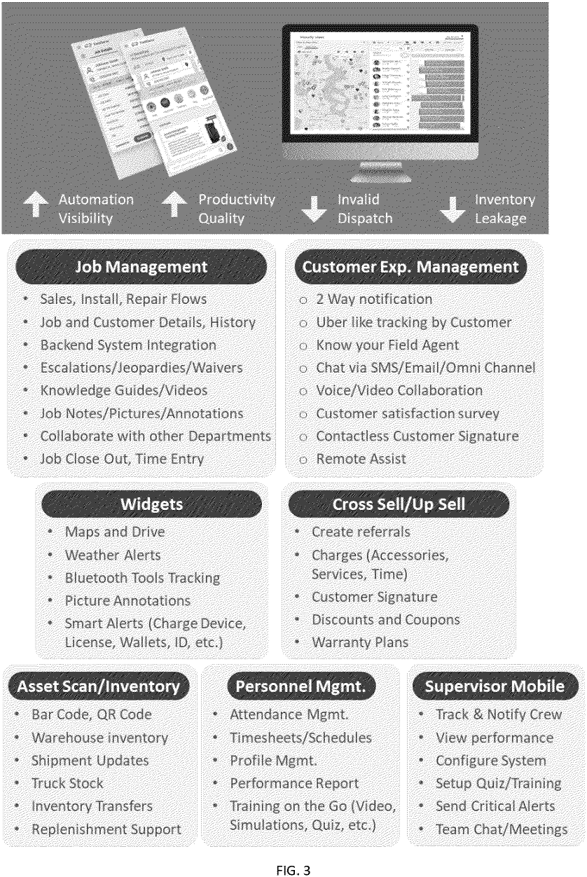

FIG. 3 illustrates some of the features of the present disclosure according to one or more embodiments of the present disclosure. As listed, the system and method thereof provide interactive communication interface and operation management for optimization of field operations and experience, quality, and productivity of the field workforce.

In an implementation according to one of the embodiments of the present disclosure the system and method thereof provide a Configuration Portal through the system platform. The platform provides out of the box configuration portal that is cloud-based and has multi-tenant architecture. Further, the platform provides multiple database options to meet the security needs of the different customer profiles including on-prem database, and database as a service (DBaaS). The configuration portal enables multiple businesses to configure their business-specific parameters and processes. The administrators are facilitated to add users/invite users for registration. The administrators can enable/disable or configure the business modules per their business needs. The platform provides industry-specific pre-configured libraries for use enabling quick time to market (e.g. module for internet speed test available for telecom users/business processes). The administrators can grant module access to users based on their role. Further, the administrators can view the reports and dashboards for various business processes.

In one of the implementations according to one of the embodiments of the present disclosure the system and method thereof provide Low code/ No code functionalities for seamless integration and adoption of various business processes/structures by receiving Low Code/No Code Data Inputs and configuring the systems accordingly. The platform provides a drag-and-drop option to build the input forms that can be used for various business processes which includes sales, ordering, installation and repair or regular maintenance services. Based on the input parameters configured, the platform provides automatic API (Application Programming Interface) details including request and response structures for the REST API usage.

In one of the implementations according to one of the embodiments of the present disclosure, the system and method thereof provide a Mobile Application, the mobile application that can be hosted and configured on a portable mobile field device. The platform provides out of the box Mobile Application that can be used by Field Agents (Field Users) to perform their field operations activities. The platform also provides out of the box Mobile Application for Managers or Supervisors to help supervisors with efficient team management functions.

In one of the implementations according to one of the embodiments of the present disclosure the system and method thereof provide a Login Module to facilitate role-based login. The Login configurations are configured by business administrators via the FieldServe Cloud configuration portal. The Users can have multiple profiles to seamlessly log in to the platform using Microsoft® Office Active Directory, LinkedIn®, Google®, Facebook®, SAML (Security Assertion Markup Language), and the standard user ID password approach. The login module is also configured to provide Biometric Login using Face ID, Touch ID and Multifactor Authentication using One Time Password or third-party verifications using Microsoft Authenticator.

In one of the implementations according to one of the embodiments of the present disclosure, the system and method thereof are configured to facilitate Work Management. The platform supports multiple Work Types including Sales, Ordering, Installation, Repair, or Maintenance Services. The Work Assignments can be created by the business process user or external system which includes tickets created by an external system and assigned to a specific user. The Work Assignments based on the Artificial Intelligence capabilities including the assignment based on the priority of the work, skillset required, availability of the specific field user are carried out. The assigned users are notified using the In-App notifications and users can view the job on their device. The Users can see various work assignment details and update the status. The Users can accept the assigned work, mark themselves “En-Route” as they start driving to the work location, update their status as “On-Site” when they arrive at the work location, and update the status as “Complete” or “Non-Complete” at the end of their work assignment. The Users can report the time spent on specific work functions if the work function is broken into multiple smaller parts. This information is usually needed by businesses to perform six sigma analysis and improve their business process to accomplish higher productivity.

In one of the implementations according to one of the embodiments of the present disclosure, the system and method thereof are configured to facilitate Job management. The system and method thereof facilitate the user to retrieve work assignments, job and customer details, and history and provides backend system integration. The system and method thereof through job management facilitates the management of escalations/ jeopardies and waivers. The system and method thereof through job management provides knowledge guides/videos, job notes, pictures, and annotations and facilitates collaboration with other departments, performing job closeout and time entries.

In one of the implementations according to one of the embodiments of the present disclosure the system and method thereof is configured to provide Customer Experience Management. The platform to provide Customer Experience Management enables two-way communication and engagement between Field Agent and a Customer. The Customers are automatically notified as Field Agent changes the status. The Customer notifications have a link to view the current location of the Field Agent. Based on the security requirements configured by the Business Administrator, the picture of the Field Agent is included in the customer notifications. The Customers have an option to respond to the notification and such notifications are visible to Field Agents on their mobile devices. The platform issues an automatic customer engagement survey at the end of the work completed to receive feedback and improve the business process. The system and method thereof is configured to provide Collaboration where the Platform provides the ability for the Field Agents to send text, email, chat, video, or phone call to the customer. Any response from customers to the digital notification is visible within the FieldServe Application (35). The system and method thereof is further configured to provide Contactless Customer Signature. The platform provides the ability for the Field Agents to generate the customer consent notices that customers need to sign. Such notices are sent to the customer’s email address, or the link is texted to the user’s mobile phone. The platform is also configured to generate the unique QR Code (Quick Response Code) that is displayed on Field Agent’s mobile device. Customers can scan the QR code using their personal device and view and provide their consent using their own device thus avoiding any contact with Field Agent’s mobile device

In one of the implementations according to one of the embodiments of the present disclosure the system and method thereof is configured to provide a plurality of Widgets. The plurality of Widgets include a first widget that generates and provides Smart Alerts to remind the users to collect their important documents, driving license, company ID, vehicle registration papers and insurance papers. which could be useful if the law enforcement authorities ask for such information. The platform also provides a second widget that captures Field Agent’s device battery status and reminds them to charge the device once the battery level is below 60% as opposed to default device reminders of 20%. This is to avoid any potential work stoppage due to the device battery being discharged. The plurality of widgets further includes a third widget to view all the work assignment locations on a single screen and plan the day and drive accordingly. The platform allows one-click access to directions using seamless integration with map apps which includes Google Maps app on the device. The platform also captures the driving speed, distance, and break times and prompts users to take breaks and update status for the driving analytics. Further, a fourth widget is for the Field Agents to connect and tag through Bluetooth Devices, the other devices they carry which includes laptops, meters, tools and drillers. If any device is missing or loses connectivity, then the platform prompts the user immediately thus avoiding a potential loss of such devices at the work locations. The platform is integrated with third-party weather information systems that capture and automatically capture the important weather information and prompt Field Agents with weather alerts to manage their tasks accordingly. The platform continuously tracks the cellular connectivity status of the device and determines if the device is alive or not. If the device loses cellular connectivity. then the platform updates the work functions accordingly and as needed takes subsequent actions to avoid any work schedule slippage. The Platform tracks the Hot Spot connections used by various users and keeps an up-to-date repository of the Hot Spot connections within a specific geographic region. If the device loses cellular connectivity, then it prompts users with the nearest Hot Spot locations so users can connect and perform their work functions. This feature is extremely useful in remote areas where cellular network is not strong or not available.

In one of the implementations according to one of the embodiments of the present disclosure, the system and method thereof is configured to facilitate the Cross Sell and Up Sell where the platform provides out of the box product catalog that Business Administrators can configure for various products and services that can be sold by the Field Agent while at customer premises. Platform catalog supports the Accessories, Services, and Time-based rate cards for various market segments. This module is seamlessly integrated with customer consent and the contactless customer signature module.

In one of the implementations according to one of the embodiments of the present disclosure the system and method thereof is configured to facilitate Personal and Human Resource (HR) functions. The platform provides Field Agents to undergo training using video and documents. The Specific knowledge videos and documents are displayed to Field Agents as they log in to the mobile application. Users also have an option to skip and remind themselves later of any such knowledge content. The Field Agents can manage their profile to receive specific knowledge articles, and system alerts based on their preferences. Further, the Field Agents can view their performance and use this information to improve their productivity. The Business Administrators can configure specific business process training that will be available for Field Agents on their mobile devices. The Field Agents can view their schedules, update schedules, and request for time off or similar schedule changes.

In one of the implementations according to one of the embodiments of the present disclosure, the system and method thereof is configured to facilitate asset scan through Bar code scan, and QR code scan. The system and method thereof is further configured to facilitate inventory access and management by providing linkages through Warehouse inventory, Shipment updates, Truck stock, inventory transfers, and replenishment support.

In one of the implementations according to one of the embodiments of the present disclosure the system and method thereof is configured to facilitate the user with personnel management through attendance management, timesheets/schedules management, profile management, performance report generation, and training on the go.

The system and method is configured to facilitate the manager through mobile to track & notify crew, view performance, configure the system, setup quiz/training, send critical alerts and perform team chat and meetings.

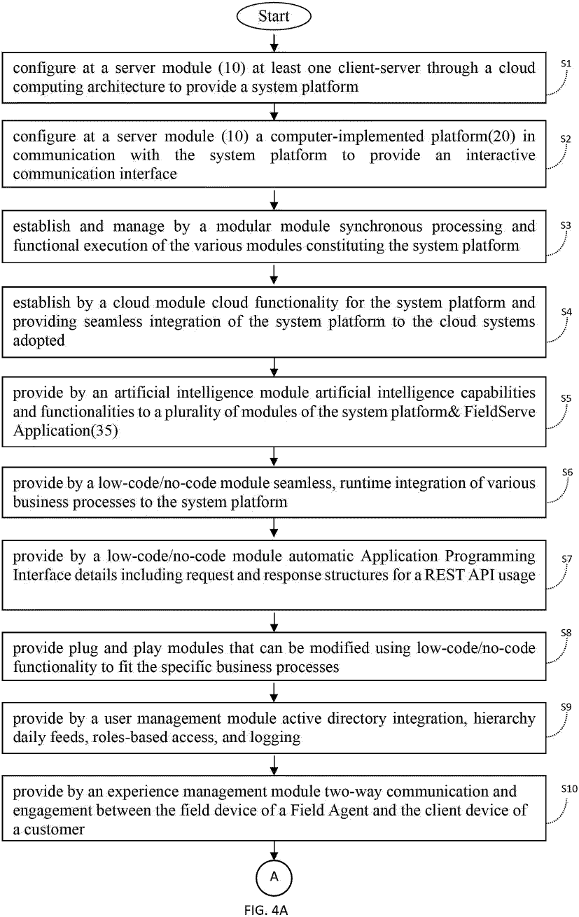

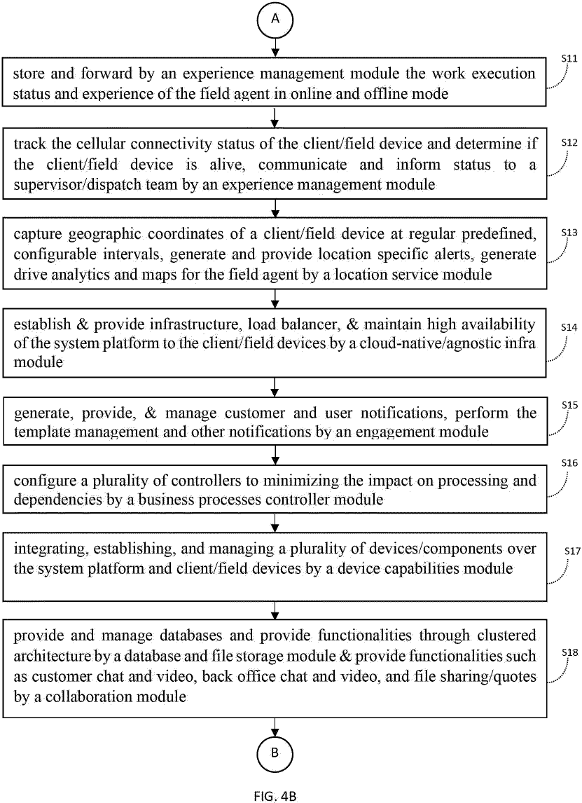

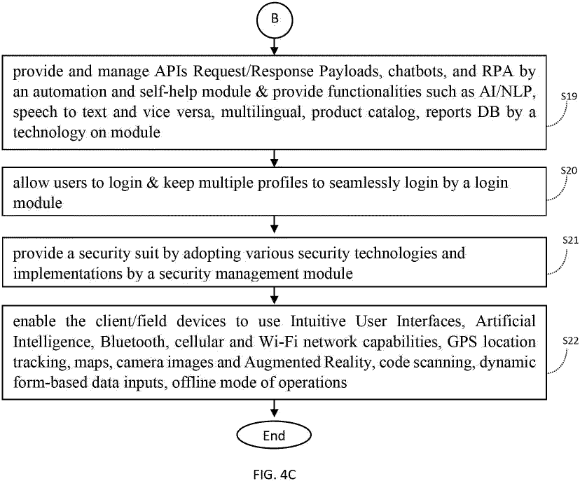

FIG. 4A, FIG. 4B and FIG. 4C illustrates an execution flow of the method of the present disclosure duly executed by the system of the present disclosure. In one of the implementations according to one of the embodiments, a method of the present disclosure includes steps of configuring at a server module (10) at least one client-server through a cloud computing architecture to provide a system platform (S1). The method includes step of configuring at a server module (10) a computer-implemented platform (20) in communication with the system platform to provide an interactive communication interface for the finest user experience in the data, information exchange and communication (S2). The method includes step of establishing and managing synchronous processing and functional execution of the various modules constituting the system platform by a modular interface configured in the system platform (S3). The method includes step of establishing cloud functionality for the system platform and providing seamless integration of the system platform to the cloud systems adopted by a cloud module configured in the system platform (S4). The method includes step of providing artificial intelligence capabilities and functionalities to a plurality of modules constituting the system platform and a FieldServe Application (35) by an artificial intelligence (AI) module configured in the system platform (S5). The method includes step of providing seamless, runtime integration of various business processes to the system platform through a low-code/no-code approach (S6) and providing automatic Application Programming Interface details including request and response structures for a RESTful (representational state transfer) API usage by a low-code/no-code module configured in the system platform (S7). The method includes step of providing plug and play modules that can be modified using low-code/no-code functionality to fit the specific business processes (S8). The method includes step of providing active directory integration, hierarchy daily feeds, roles-based access, and logging by a user management module configured in the system platform (S9). The method includes step of providing two-way communication and engagement between the field device of a Field Agent and the client device of a customer (S10), storing and forwarding the work execution status and experience of the field agent in online and offline mode (S11), and tracking the cellular connectivity status of the client/field device and determining if the client/field device is alive, communicating and informing status to a supervisor/dispatch team by an experience management module configured in the system platform (S12). The method includes step of capturing geographic coordinates which includes latitude and longitude information of a client/field device at regular predefined, configurable intervals, generate and provide location specific alerts, generate drive analytics and maps for the field agent by a location service module configured in the system platform (S13). The method includes step of establishing and providing infrastructure which includes operating systems, providing load balancer, and maintaining high availability of the system platform to the client/field devices hosting the FieldServe Application (35) by a cloud-native/agnostic infra module configured in the system platform (S14). The method includes step of generating, providing, and managing customer and user notifications, performing the template management and other notifications by an engagement module configured in the system platform (S15). The method includes step of configuring a plurality of controllers which includes process-specific controllers to manage the execution of a plurality of independent processes by minimizing the impact on processing and dependencies by a business processes controller module configured in the system platform (S16). The method includes step of integrating, establishing, and managing a plurality of devices/components to include, integrate, execute and manage the associated functionalities of the said plurality of devices over the system platform and client/field devices by a device capabilities module configured in the system platform (S17). The method includes step of providing and managing databases and providing functionalities through clustered architecture to provide high availability by a database and file storage module configured in the system platform (S18). The method includes step of providing functionalities which includes customer chat and video, back-office chat and video, and file sharing/quotations by a collaboration module configured in the system platform (S18). The method includes step of providing and managing APIs Request/Response Payloads, chatbots, and RPA by an automation and self-help module configured in the system platform (S19). The method includes step of providing functionalities which includes AI/NLP, speech to text and vice versa, multilingual, product catalog, reports DB by a technology on module configured in the system platform (S19). The method includes step of allowing users to login and keep multiple profiles to seamlessly login to the platform by using login credentials by a login module configured in the system platform (S20). The method includes step of providing a security suit by adopting various security technologies and implementations by a security management module configured in the system platform (S21). The method includes step of enabling the client/field devices to use Intuitive User Interfaces, Artificial Intelligence, Bluetooth, cellular and Wi-Fi network capabilities, GPS location tracking, maps, camera images and Augmented Reality, code scanning, dynamic form-based data inputs, offline mode of operations (S22).

According to the method of the present disclosure duly executed by the system of the present disclosure the system platform in connection with the computer-implemented platform (20) provides various capabilities that are required in an enterprise field service operations platform, optimizing field operations and experience, quality, and productivity of the field workforce, that is useable, scalable, and independent of new technology platforms, by using minimum resources by enabling the client/field devices to use Intuitive User Interfaces, Artificial Intelligence, Bluetooth, cellular and Wi-Fi network capabilities, GPS location tracking, maps, camera images and Augmented Reality, code scanning, dynamic form based data inputs and offline mode of operations to streamline the complex business processes. The method of the present disclosure duly executed by the system of the present disclosure the system platform in connection with the computer-implemented platform (20) further provides plug and play modules that can be modified using low-code/no-code functionality to fit the specific business processes which includes door-to-door sales, service installation, service repair, service maintenance, site surveys, such that the computer implemented platform (20) providing an interactive communication interface for optimized field operation, enhance productivity and experience of the field workforce and is flexible to accommodate new business flows, processes with minimal or no manual efforts, while efficiently increasing the throughput of the field workforce and profitability.

Advantages:
1. The system and method thereof have Cloud based and modular architecture that enables plug and play and quick time to market approach for the business administrators to configure the system for their specific use.
2. Comprehensive platform that addresses many key challenges of the field operations organizations which includes dynamic business changes, customer collaboration and interaction, up to date work assignment information.
3. User Interface designed to bring simplicity and intuitive approach for the field users.
4. Industry specific libraries (which includes Telecom, Pest Control, Home Warranty and Repair services) based on the domain expertise.
5. Artificial Intelligence analytical technologies for the drive analytics and work assignment to specific users based on skill, type of the work.
6. End to End workflow management from work assignment creation to completion.
7. User specific personal modules to drive accountability, improve productivity.

The present disclosure as implemented through various embodiments is economically viable and can be adopted by the businesses easily as it provides the best interaction experience to the user and optimization of operation management.

According to one of the preferred embodiments, the system and method thereof of the present disclosure may be implemented as a client server network.

According to one of the preferred embodiments, the system and method thereof of the present disclosure may be implemented over a cloud computing platform.

In some embodiments, the disclosed techniques can be implemented, at least in part, by computer program instructions encoded on a non-transitory computer-readable storage media in a machine-readable format, or on other non-transitory media or articles of manufacture. Such computing systems (and non-transitory computer-readable program instructions) can be configured according to at least some embodiments presented herein, including the processes shown and described in connection with Figures.

The programming instructions can be, for example, computer executable and/or logic implemented instructions. In some examples, a computing device is configured to provide various operations, functions, or actions in response to the programming instructions conveyed to the computing device by one or more of the computer readable medium, the computer recordable medium, and/or the communications medium. The non-transitory computer readable medium can also be distributed among multiple data storage elements, which could be remotely located from each other. The computing device that executes some or all of the stored instructions can be a server, or another computing platform. Alternatively, the computing device that executes some or all of the stored instructions could be remotely located computer system or server.

Further, while one or more operations have been described as being performed by or otherwise related to certain modules, devices or entities, the operations may be performed by or otherwise related to any module, device or entity.

Further, the operations need not be performed in the disclosed order, although in some examples, an order may be preferred. Also, not all functions need to be performed to achieve the desired advantages of the disclosed system and method, and therefore not all functions are required.

While select examples of the disclosed system and method have been described, alterations and permutations of these examples will be apparent to those of ordinary skill in the art. Other changes, substitutions, and alterations are also possible without departing from the disclosed system and method in its broader aspects. Accordingly, various modifications may be made without departing from the spirit or scope of the general inventive concept as defined in the specification and their equivalents.

We claim:

1. A system for operations management, comprising:
a server module (10) having at least one client server having a cloud computing architecture to provide a system platform, wherein the system platform comprises a first processor communicatively coupled to a first memory having at least one application server, the system platform configured to include a modular interface, a cloud module, an artificial intelligence (AI) module, a low/no code module, a user management module, an experience management module, a location service module, a cloud native and agnostic infra module, an engagement module, a business processes controller module, a device capabilities module, a database and file storage module, a collaboration module, an automation and self-help module, a technology on module, a login module, a security management module and an integration gateway third party connectors module configured to provide connectivity to an existing business support system and a third party system;
a computer implemented (20) platform in communication with the system platform, the computer implemented platform (20) having a second processor in communication with a second memory stored with an application coupled to a communication network; and
a plurality of client devices each having a respective third processor in communication with a respective third memory and utility components facilitating data connectivity and communication over a communication network, wherein the client devices are each configured with an application module configured to communicate with the client server over the communication network;
wherein the system platform is configured to enable the client devices to use intuitive user interfaces, AI, Bluetooth, cellular and WiFi network capabilities, global positioning system (GPS) location tracking, maps, camera pictures and augmented reality (AR), code scanning, dynamic form based data inputs and offline mode of operations to streamline business processes and provide plug and play modules that are modified using low-code/no-code functionality to fit business processes including door-to-door sales, service installation, service repair, service maintenance, site surveys, such that the computer implemented platform (20) provides an interactive communication interface for improved field operation, enhances productivity and experience of a field workforce and is configured to accommodate new business flows, processes with reduced or no manual efforts, while increasing a throughput of the field workforce and profitability.

2. The system of claim 1, wherein the utility components include image capturing devices including a camera, bar code and quick response (QR) scanner, interactive display, and a communication module capable of providing connectivity and communication over the communication network.

3. The system of claim 1, wherein the computer implemented platform (20) comprises a cloud-based computer and a mobile platform that is configured to use AI, cellular and wireless networks, Bluetooth, GPS location, and a camera to view and complete field assignments.

4. The system of claim 1, wherein the system platform is configured to provide a configuration web portal, a field tech application module, and a manager application module.

5. The system of claim 1, wherein the client devices are configured with a mobile application for utilizing secured connectivity with a cloud platform and allowing secured download of configuration parameters that can be used during an offline mode in case of network connectivity loss.

6. The system of claim 5, wherein the mobile application is configured to utilize advanced device capabilities including Bluetooth, WiFi, and cellular antennas, GPS and location tracking, form-based data inputs, camera, AR, bar code, and QR code scanning.

7. The system of claim 1, wherein the database and file storage module is configured to provide and manage databases in the system platform.

8. The system of claim 1, wherein the security management module is configured to provide a security suit by adopting various security technologies and implementations including Citrix® XenMobile, Microsoft® Authenticator, Google® Ent, SAML (Security Assertion Markup Language), SSO (Single Sign On), JWT (JSON Web Token) Token and ID/P MFA (ID Password Multi Factor Authentication).

9. The system of claim 1, wherein the system platform is configured with a cloud-based configuration portal having a multi-tenant architecture.

10. The system of claim 9, wherein the cloud-based configuration portal is configured to provide multiple data base options to meet security needs of a plurality of customer profiles enabling multiple businesses to configure business specific parameters and processes, facilitating users and administrators to add/invite other users for registration, enable and disable or configure business modules per business needs, grant access to users based on their role and view reports and dashboards for various business processes.

11. The system of claim 9, wherein the cloud-based configuration portal allows multiple data base options to meet security needs of different customer profiles including an on-prem database, and a database as a service (DBaaS).

12. A method of operations management, the method comprising:
configuring at a server module (10) at least one client-server having a cloud computing architecture to provide a system platform;
configuring at the server module (10) a computer-implemented platform (20) in communication with the system platform to provide an interactive communication interface for a user experience in the data, information exchange and communication;
establishing and managing, by a modular interface configured in the system platform, synchronous processing and functional execution of modules comprising the system platform;
establishing, by a cloud module configured in the system platform, cloud functionality for the system platform and providing seamless integration of the system platform to adopted cloud systems;
providing, by an artificial intelligence (AI) module configured in the system platform, AI capabilities and functionalities to a plurality of modules comprising the system platform and a fieldserve application (35);
providing, by a low-code/no-code module configured in the system platform, seamless, runtime integration of business processes to the system platform through a low-code and no code approach and providing automatic application programming interface details including request and response structures for a representational state transfer (REST) application programming interface (API) usage;
providing, by a user management module configured in the system platform, active directory integration, hierarchy daily feeds, roles-based access, and logging;
providing, by an experience management module configured in the system platform, two-way communication and engagement between a field device of a field agent and a client device of a customer, storing and forwarding work execution status and experience of the field agent in an online and offline mode, and tracking cellular connectivity status of the client device and determining if the client device is alive, communicating and informing status to a supervisor/dispatch team;
capturing, by a location service module configured in the system platform, geographic coordinates including latitude and longitude information of the client device at regular predefined, configurable intervals, generate and provide location specific alerts, generate drive analytics and maps for the field agent;
establishing and providing, by a cloud-native/agnostic infra module configured in the system platform, infrastructure including operating systems, providing load balance, and maintaining availability of the system platform to the client devices hosting the fieldserve application (35);
generating, providing, and managing, by an engagement module configured in the system platform, customer and user notifications, performing template management and notifications;
configuring, by a business processes controller module configured in the system platform, a plurality of controllers including process-specific controllers to manage execution of a plurality of independent processes by reducing impact on processing and dependencies;
integrating, establishing, and managing, by a device capabilities module configured in the system platform, a plurality of devices to include, integrate, execute and manage associated functionalities of the plurality of devices over the system platform and client devices;
providing and managing, by a database and file storage module configured in the system platform, databases and providing functionalities through clustered architecture to provide increased availability;
providing, by a collaboration module configured in the system platform, functionalities including customer chat and video, back-office chat and video, and file sharing and quotations;
providing and managing, by an automation and self-help module configured in the system platform, application programming interface (API)s request and response payloads, chatbots, and RPA (robotic process automation);
providing, by a technology on module configured in the system platform, functionalities including AI/NLP (natural language processing), speech to text and text to speech, multilingual, product catalog, reports database (DB);
allowing, by a login module configured in the system platform, users to login and keep multiple profiles to seamlessly login to the system platform by using login credentials;
providing, by a security management module configured in the system platform, a security suit by adopting security technologies and implementations;
wherein the system platform in connection with the computer-implemented platform (20) provides capabilities of an enterprise field service operations platform, increasing field operations and experience, quality, and productivity of a field workforce, that is useable, scalable, and independent of new technology platforms, by using reduced resources by enabling the client devices to use intuitive user interfaces, AI, Bluetooth, cellular and Wi-Fi network capabilities, global positioning system (GPS) location tracking, maps, camera images and augmented reality (AR), code scanning, dynamic form based data inputs and offline mode of operations to streamline business processes and providing plug and play modules that can be modified using low-code and no-code functionality to fit business processes including door-to-door sales, service installation, service repair, service maintenance, site surveys, such that the computer implemented platform (20) provides an interactive communication interface for improved field operation, enhances productivity and experience of the field workforce and is flexible to accommodate new business flows, processes with reduced or no manual efforts, while increasing throughput of the field workforce and profitability.

13. The method of claim 12, wherein the system platform is configured for providing a functionality of job management by facilitating users to retrieve work assignments, job and customer details, managing escalations and jeopardies and waivers, providing knowledge guides and videos, job notes, pictures, annotations and enabling to collaborate with other departments, performing job close out and time entries.

14. The method of claim 12, wherein the database and file storage module is configured to provide and manage databases and provide functionalities which includes on-prem, data base as a service (DBaaS) through clustered architecture to provide increased availability.

15. The method of claim 12, wherein the engagement module is configured to generate, provide and manage customer and user notifications, perform template management and generate, provide and manage notifications for Firebase® and Apple® notifications.

16. The method of claim 12, wherein the computer implemented platform (20) in connection with the system platform is configured with features including AI, Bluetooth connectivity to the network devices, GPS location by means of maps and drive functions, offline mode of operations such that a field agent can work in low or no cellular network areas including remote places and basements.

17. The method of claim 12, wherein the low-code and no-code functionality allows seamless integration and adoption of a plurality of business processes and structures by receiving low-code and no-code data inputs and configuring the systems to provide a drag and drop option to build input forms that are applicable for business processes including sales, ordering, installation, repair or regular maintenance services.

18. The method of claim 12, wherein the system platform provides automatic API details including request and response structures for a representational state transfer (REST) API usage.

19. The method of claim 12, wherein the login module allows a user to login to the system platform using Microsoft® Office Active Directory, LinkedIn®, Google®, Facebook®, and security assertion markup language (SAML).

20. The method of claim 12, wherein the system platform containing the login module is configured to allow multiple profiles for users and allows a user to login to the system platform by using login credentials and biometric data which includes face identification (ID), touch ID, and multifactor authentication using one time password and third-party verifications using Microsoft® Authenticator.

21. The method of claim 12, wherein the system platform is configured to facilitate AI based work management by supporting multiple work types including sales, ordering, installation, and repair or maintenance services.

22. The method of claim 21, wherein the AI based work management includes assignment of work based on a priority of the work, skillset required, and availability of a specific field user or field agent, notifying an assigned user, allowing the user to view a job, and work assignment details, update a status and accept the assigned work using the client device, navigating the user to a work location, allowing the user to report arrival, update the work status and time spent at an end of the work assignment.

23. The method of claim 12, wherein the system platform is configured to provide customer experience management enabling a two-way communication and engagement between a field agent and a customer allowing the field agents to send text, email, chat, video or a phone call to the customer and receive responses from the customer in the form of digital notification in the fieldserve application (35).

24. The method of claim 12, wherein the system platform is configured to provide a plurality of widgets, including a first widget that provides smart alerts to remind the users about documents to be collected, a second widget that captures field device battery status and remind about recharging of the client device, a third widget that allows a user to view all work assignment locations on a single screen and plan a day and a drive, and a fourth widget that allows field agents to connect and tag other devices.

25. The method of claim 12, wherein the system platform is configured to facilitate personal and human resource (HR) functions by providing training for users or field agents by means of video and documents, allowing the field agents to receive knowledge articles based on preferences, view performance and use information to improve productivity of the field agents.

26. The method of claim 12, wherein the system platform is configured to enable business administrators to configure business process training that is made available for users or field agents on respective field devices, allowing users to view and update schedules, and send a request for time off or schedule changes.

27. The method of claim 12, wherein the system platform is configured to facilitate a user with personnel management through attendance management, timesheets and schedules management, profile management, performance report generation, and training on the go.

28. The method of claim 12, wherein the system platform is configured to facilitate a user or a manager through a smart phone to track and notify teammates, view performance, configure and setup training, send alerts and perform team chat and meetings.
